(19) United States
(12) Patent Application Publication
(10) Pub. No.: US 2001/0028958 A1
(43) Pub. Date: Oct. 11, 2001

(54) Pressed body, in particular for a cooking surface radiant heating arrangement

(75) Inventor: Rudolf Brunner, Klsslegg (DE)

Correspondence Address: Leopold Presser, Esq., Scully, Scott, Murphy & Presser, 400 Garden City Plaza, Garden City, NY, 11530, US

(73) Assignee: Diehl AKO Stiftung & Co. KG, Wangen (DE)

(21) Appl. No.: 09/826,736

(22) Filed: Apr. 5, 2001

(30) Foreign Application Priority Data
Apr. 7, 2000 (DE) 200 06 437.1

(51) Int. Cl. H01C 1/012; H05B 3/68; B32B 9/04

(52) U.S. Cl. 428/446; 219/461.1; 338/306

(57) ABSTRACT

Crack formation is to be avoided in a press-molded body, in particular for a cooking surface radiant heating arrangement, comprising a heat-insulating material. For that purpose, in a transitional zone 8 between a more compacted region 6 and a less compacted region 3, the heat-insulating material is compacted to an even greater degree than in the more compacted region.

The invention concerns a press-moulded body comprising a heat-insulating material, in particular for a cooking surface radiant heating arrangement, wherein a more compacted region and a less compacted region are in mutually adjoining relationship.

In radiant heating arrangements for cooking surfaces, a press-moulded body comprising heat-insulating material in powder form is pressed into a sheet metal shell or casing bowl. At least one electrical heating conductor is secured to the press-moulded body. The press-moulded body involves different wall thicknesses in region-wise manner, in order to satisfy demands in regard to convenient arrangement options for the heating conductor and for other components, for example a temperature sensor, and also demands in regard to heat insulation (see DE 196 38 640 A1, DE 197 37 194 A1 and DE 297 18 419 U1).

The different wall thicknesses are formed by a procedure whereby firstly the sheet metal shell or casing bowl is filled virtually to an even height with heat-insulating material in powder form such as silica aerogel or HDS (highly dispersed silica) material and optionally additives. The heat-insulating material is then pressed to afford the desired contour by means of a pressing die or ram (DE 30 34 775 C2). That procedure affords regions which are compacted to different degrees.

It has been found that, in a press-moulded body produced in that way, cracks occur between the more compacted and the less compacted regions. Such crack formation can be attributed to the fact that material which is compacted to a greater degree is pushed in the course of the pressing operation into or under the less compacted region of the material.

Crack formation of that kind is detrimental in terms of utilitarian suitability of the radiant heating arrangement because the assembly may suffer from detachment of layers or pieces crumbling away, in the region of the cracks. The damage is considerable in such a situation because the press-moulded body as such in the radiant heating arrangement or the sheet metal shell or casing bowl cannot be replaced. In a damage situation, it is necessary for the entire radiant heating arrangement to be removed.

The object of the present invention is to propose a press-moulded body of the kind set forth in the opening part of the present specification, in which crack formation is avoided in the operation for shaping the moulded body.

In accordance with the invention the foregoing object is attained in that, in a transitional zone between the more compacted region and the less compacted region, the heat-insulating material is compacted to an even greater degree than in the more compacted region.

That procedure ensures that, in the operation of shaping the more compacted region, material is not pressed into the less compacted region. For, the transitional zone which is compacted to an even greater degree forms a barrier which substantially prevents material from the more compacted region being pressed into the less compacted region.

It has been found that the measure set forth in claim 1 very substantially suppresses crack formation in the less compacted region. This means that there is no fear of substantial crack formation on the press-moulded body. It is desirable in that respect that the reject or wastage factor of press-moulded bodies which are formed in that way is low and the durability of the bodies is improved.

The wall thickness of the press-moulded body is less in the more compacted region, than in the less compacted region. Corresponding to the higher degree of compacting, the wall thickness in the transitional zone is even smaller than in the more compacted region.

Preferably, the volume of the transitional zone in which the heat-insulating material is compacted to an even greater degree than in the more compacted region, is smaller than the volume of the more compacted region. Accordingly, the still more compacted transitional zone does not in turn give rise to crack formation, but forms a narrow, highly compacted strip.

Preferably, the transitional zone is formed in such a configuration, by means of a bead or ridge of the pressing tool, that the transitional zone forms a cross-sectional profile which is open upwardly in a V-shape. The transitional zone is thus at the same time an open expansion joint which, when changes in temperature occur, suppresses loadings on the less compacted region by the more compacted region.

Preferably, the press-moulded body is pressed into a shell or casing bowl and the more compacted region adjoins the edge of the shell or casing bowl.

Further advantageous configurations of the invention are set forth in the appendant claims and are apparent from the following description of an embodiment by way of example. In the drawing:

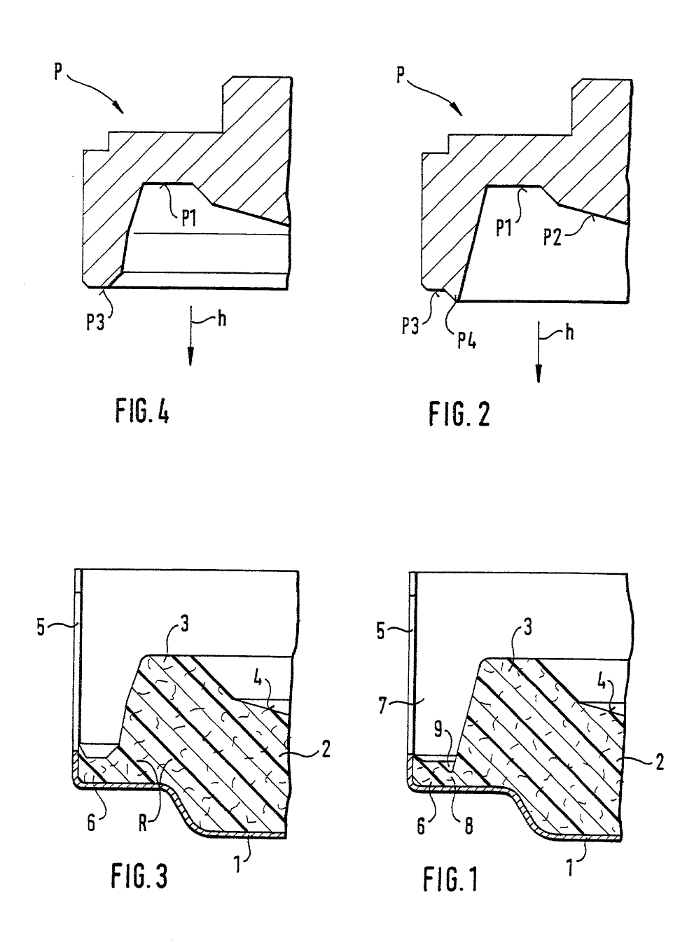

FIG. 1 shows a partial section of a press-moulded body in a shell or casing bowl,

FIG. 2 shows a pressing die for moulding the press-moulded body of FIG. 1 in the shell or casing bowl,

FIG. 3 shows by way of comparison a partial section of a press-moulded body in accordance with the state of the art and,

FIG. 4 shows a pressing die for moulding the pressed body of FIG. 3 in accordance with the state of the art.

A radiant heating arrangement for a cooking area of a glass ceramic plate has a prefabricated shell or casing bowl 1, in particular a metal casing bowl (see FIG. 1). A heat-insulating material which forms a press-moulded body 2 is pressed into the casing bowl 1 by means of a pressing die P (see FIG. 2). The heat-insulating material is specifically an HDS-mixture, that is to say a mixture based on highly dispersed silica, which is very light and powdery in the unpressed condition.

At its surface which is remote from the casing bowl 1, the press-moulded body 2 is of a contour which is established on the basis of structural needs and the needs of heat insulation. As shown in FIG. 1, the press-moulded body 2 forms an upstanding annular edge portion 3 and a bottom 4 which is lower than the edge portion 3. Provided outside the annular edge portion 3 between same and the edge 5 is a region 6 whose height or wall thickness is substantially smaller than the height or wall thickness of the annular edge portion 3 and the bottom 4. An electrical heating conductor (not shown) can be secured to the annular edge portion 3 and extends above the bottom 4. An insulating ring can be fitted on to the annular edge portion 3. Between the edge 5 of the casing bowl 1 and the annular edge portion 3, above the region 6, there is a free space 7 which is suitable for accommodating other components, for example electrical connections, of the radiant heating arrangement.

The surface contour of the press-moulded body 2 is afforded by a procedure whereby firstly the heat-insulating material in powder form is introduced approximately to an equal level into the casing bowl 1 and then the pressing die P which is of the contour corresponding to the desired surface contour of the press-moulded body 2 is pressed on to the heat-insulating material in the pressing direction h. The pressing die P has a contour zone P1 for shaping the annular edge portion 3, a contour zone P2 for pressing the bottom 4 and a contour zone P3 for pressing the region 6. A projecting bead or ridge P4 is provided on the pressing die P, between the contour zone P3 and the contour zone P1.

When the pressing die P is pressed against the heat-insulating material in the pressing direction h, that gives rise to the region 6 in which the heat-insulating material is compacted to a greater degree than in the region of the annular edge portion 3 and the bottom 4. The projecting bead or ridge P4 produces in the press-moulded body 2 a transitional zone 8 in which the heat-insulating material is compacted to an even greater degree than in the region 6. In a corresponding manner, the wall thickness in the transitional zone 8 is smaller than in the region 6 and very much smaller than in the region of the annular edge portion 3 and the bottom 4. In the course of the pressing operation, the transitional zone 8 is compacted in leading relationship, so that it forms a barrier which substantially prevents heat-insulating material from being pressed out of the region 6 into the region of the annular edge portion 3 in the step of pressing the region 6, which could result in unwanted crack formation. The volume or cross-section of the transitional zone 8 is substantially smaller than the volume or cross-section of the region 6 so that no substantial amounts of material which give rise to cracks are pressed out of the transitional zone 8 into the adjoining regions 6, 3.

The transitional zone 8 forms on the press-moulded body 2 a cross-sectional profile 9 which is open upwardly and which is of a V-shaped configuration (see FIG. 1), which acts as an open expansion joint.

If necessary a transitional zone of the described kind can be provided between further regions in which the wall thickness of the press-moulded body 2 is greatly different.

For the purposes of comparison with the state of the art, attention is directed to FIGS. 3 and 4. Therein the pressing die P (see FIG. 4) does not have the bead or ridge P4 so that the press-moulded body 2 does not involve a transitional zone in which the heat-insulating material is compacted to a greater degree than in the region 6. In the operation of pressing the region 6, material is then pushed into the region of the annular edge portion 3, and this results in crack formation in that region. In FIG. 3, the zone of crack formation is denoted by reference R.

1. A press-moulded body, in particular for a cooking surface radiant heating arrangement, comprising a heat-insulating material, wherein a more compacted region and a less compacted region are in mutually adjoining relationship characterised in that in a transitional zone (8) between the more compacted region (6) and the less compacted region (3), the heat-insulating material is compacted to an even greater degree than in the more compacted region (6).

2. A press-moulded body according to claim 1 characterised in that the wall thickness of the press-moulded body (2) in the more compacted region (6) is smaller than in the less compacted region (3) and that the wall thickness in the transitional zone (8) is still smaller than in the more compacted region (6).

3. A press-moulded body according to claim 1 or claim 2 characterised in that the volume or the cross-section of the transitional zone (8) is smaller than the volume or the cross-section of the more compacted region (6) and the less compacted region (3).

4. A press-moulded body according to one of the preceding claims characterised in that the transitional zone (8) forms a cross-sectional profile (9) which is open in a V-shape.

5. A press-moulded body according to one of the preceding claims characterised in that the transitional zone (8) forms an open expansion joint between the more compacted region (6) and the less compacted region (3).

6. A press-moulded body according to one of the preceding claims characterised in that the press-moulded body (2) is pressed into a shell (1).

7. A press-moulded body according to one of the preceding claims characterised in that the more compacted region (6) adjoins an edge (5) of the shell (1).
